(19) United States
(12) Patent Application Publication
(10) Pub. No.: US 2015/0208569 A1
(43) Pub. Date: Jul. 30, 2015

(54) Rock Picking System

(71) Applicant: Lester F. Pritchard, Ulen, MN (US)

(72) Inventor: Lester F. Pritchard, Ulen, MN (US)

(21) Appl. No.: 14/167,136

(22) Filed: Jan. 29, 2014

(51) Int. Cl. A01B 43/00

(52) U.S. Cl. CPC A01B 43/00

(57) ABSTRACT

A rock picking system for efficiently picking rocks from a field. The rock picking system generally includes a frame, a reel unit rotatably connected to a front portion of the frame, a motor mechanically connected to the reel unit to cause rotation of the reel unit, and a plurality of front teeth extending forwardly and downwardly from a lower front end of the frame. The reel unit includes a plurality of teeth that assist in pushing rocks in a field over the front teeth by providing a rearward and upward force to the rocks as they engage the front teeth.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a rock picker and more specifically it relates to a rock picking system for efficiently picking rocks from a field.

2. Description of the Related Art

Any discussion of the related art throughout the specification should in no way be considered as an admission that such related art is widely known or forms part of common general knowledge in the field.

Rock pickers have been in use for years for removing undesirable rocks from a field. Conventional rock pickers are typically comprised of a hitch that is connected to the rear end of a tractor and pulled behind the tractor. While a conventional rock picker is capable of removing rocks from a field, conventional rock pickers are positioned behind a tractor requiring the operator to repeatedly turn their head to view the operation of the rock picker. Another problem with conventional rock pickers is that they are not designed to effectively engage and remove rocks as their teeth extend forwardly which can push or bury the rock upon engagement.

Because of the inherent problems with the related art, there is a need for a new and improved rock picking system for efficiently picking rocks from a field.

### BRIEF SUMMARY OF THE INVENTION

The invention generally relates to a rock picker which includes a frame, a reel unit rotatably connected to a front portion of the frame, a motor mechanically connected to the reel unit to cause rotation of the reel unit, and a plurality of front teeth extending forwardly and downwardly from a lower front end of the frame. The reel unit includes a plurality of teeth that assist in pushing rocks in a field over the front teeth by providing a rearward and upward force to the rocks as they engage the front teeth.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention attached to a tractor (e.g. skid steer loader).

FIG. 2 is an upper perspective view of the present invention.

FIG. 3 is an exploded upper perspective view of the present invention with the reel unit removed from the frame.

FIG. 4 is a top view of the present invention.

FIG. 5 is a front view of the present invention.

FIG. 6 is a rear view of the present invention.

FIG. 7 is a left side view of the present invention.

FIG. 8a is a left side cutaway view of the present invention being utilized in a field to retrieve rocks from the field.

FIG. 8b is a left side cutaway view of the present invention with the reel unit and front teeth forcing the rocks into the storage space of the frame of the present invention.

### DETAILED DESCRIPTION OF THE INVENTION

### A. Overview

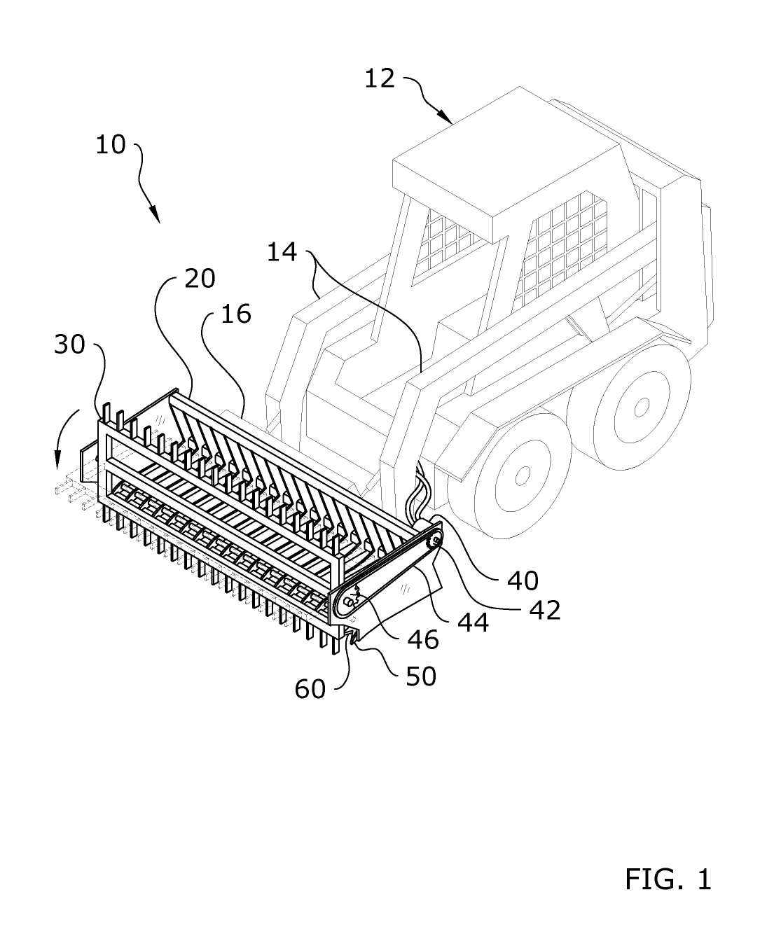

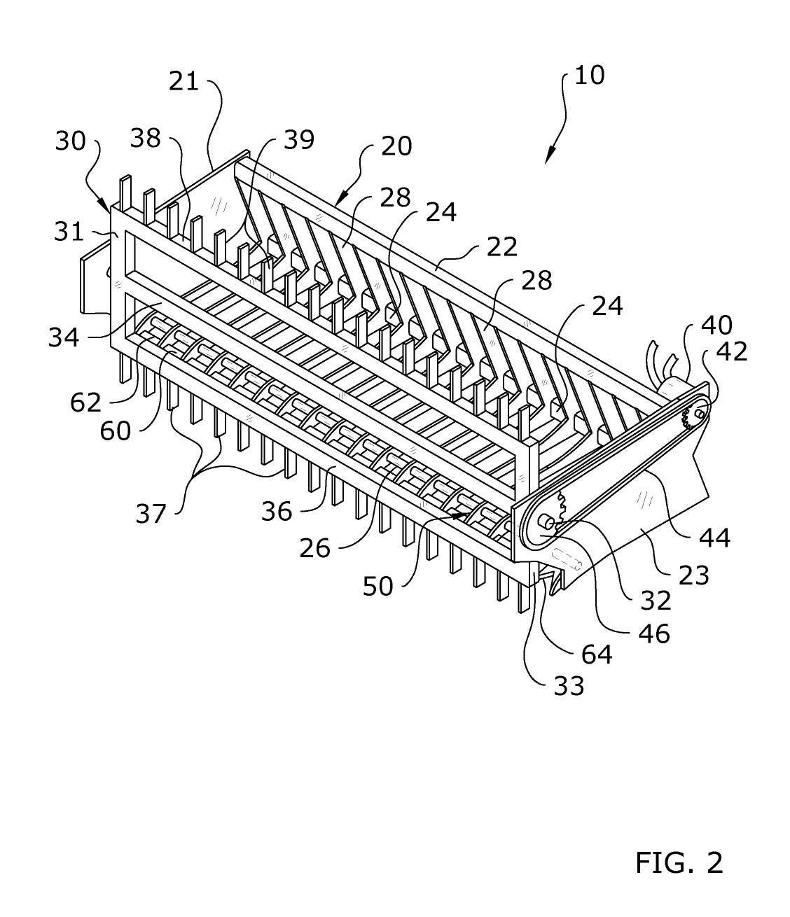

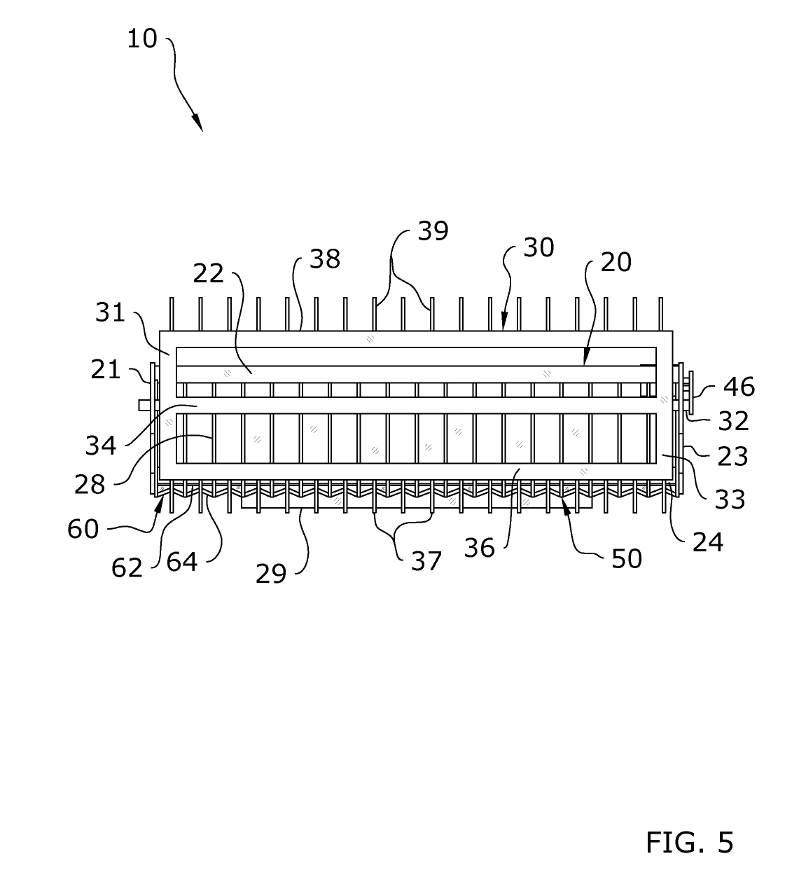

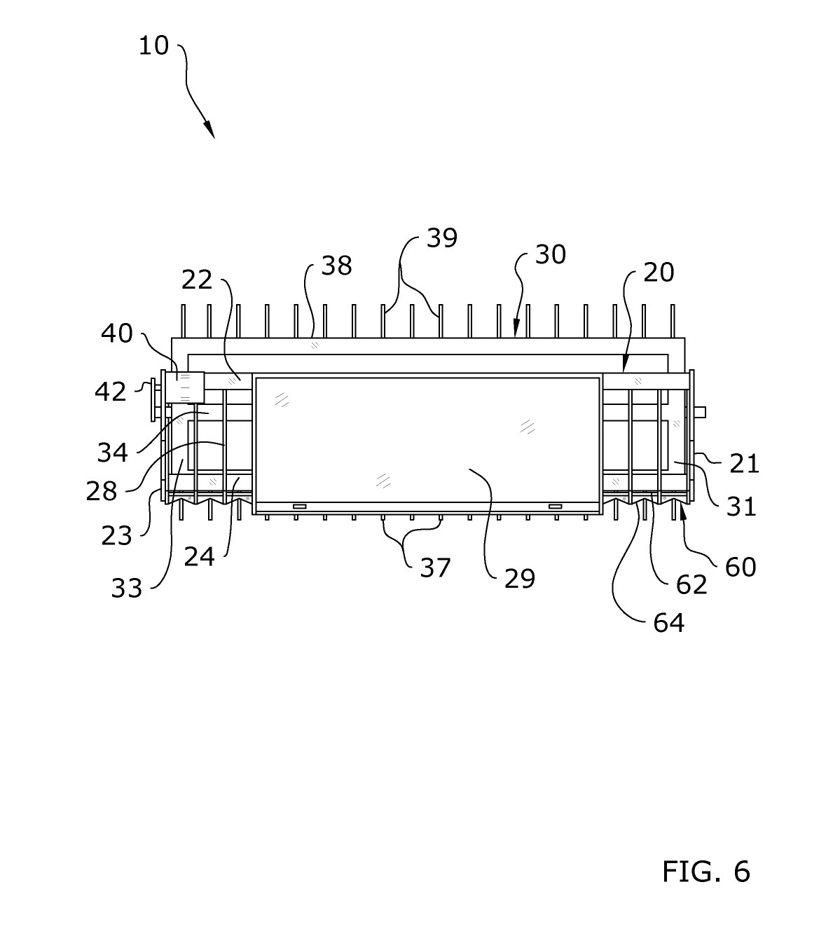

Turning now descriptively to the drawings, in which similar reference characters denote similar elements throughout the several views, FIGS. 1 through 8b illustrate a rock picking system 10, which comprises a frame 20, a reel unit 30 rotatably connected to a front portion of the frame 20, a motor 40 mechanically connected to the reel unit 30 to cause rotation of the reel unit 30, and a plurality of front teeth 50 extending forwardly and downwardly from a lower front end of the frame 20. The reel unit 30 includes a plurality of teeth that assist in pushing rocks 11 in a field 13 over the front teeth 50 by providing a rearward and upward force to the rocks 11 as they engage the front teeth 50.

### B. Frame

FIGS. 1 through 8b illustrate an exemplary frame 20 having a storage space that receives a plurality of rocks 11 and other debris of various sizes. The frame 20 may be comprised of various other structures capable of receiving, storing and dispensing rocks 11. The frame 20 preferably includes a first sidewall 21, a second sidewall 23, an upper member 22 extending between an upper rear portion of the sidewalls, a lower member 24 extending between a lower rear portion of the sidewalls and a front member 26 extending between a lower front portion of the sidewalls.

The frame 20 includes a rear connector 29 attached to a rear portion, wherein the rear connector 29 is adapted to be connected to a loader system of a tractor 12. The rear connector 29 is preferably comprised of a quick attach structure to connect to a corresponding loader connector 16 of a skid steer loader. The user of the tractor 12 is able to easily view the operation of the present invention, lift/lower the elevation of the frame 20 and control the rotation of the reel unit 30 from the tractor 12. The tractor 12 used with respect to the present invention is preferably comprised of a skid steer loader.

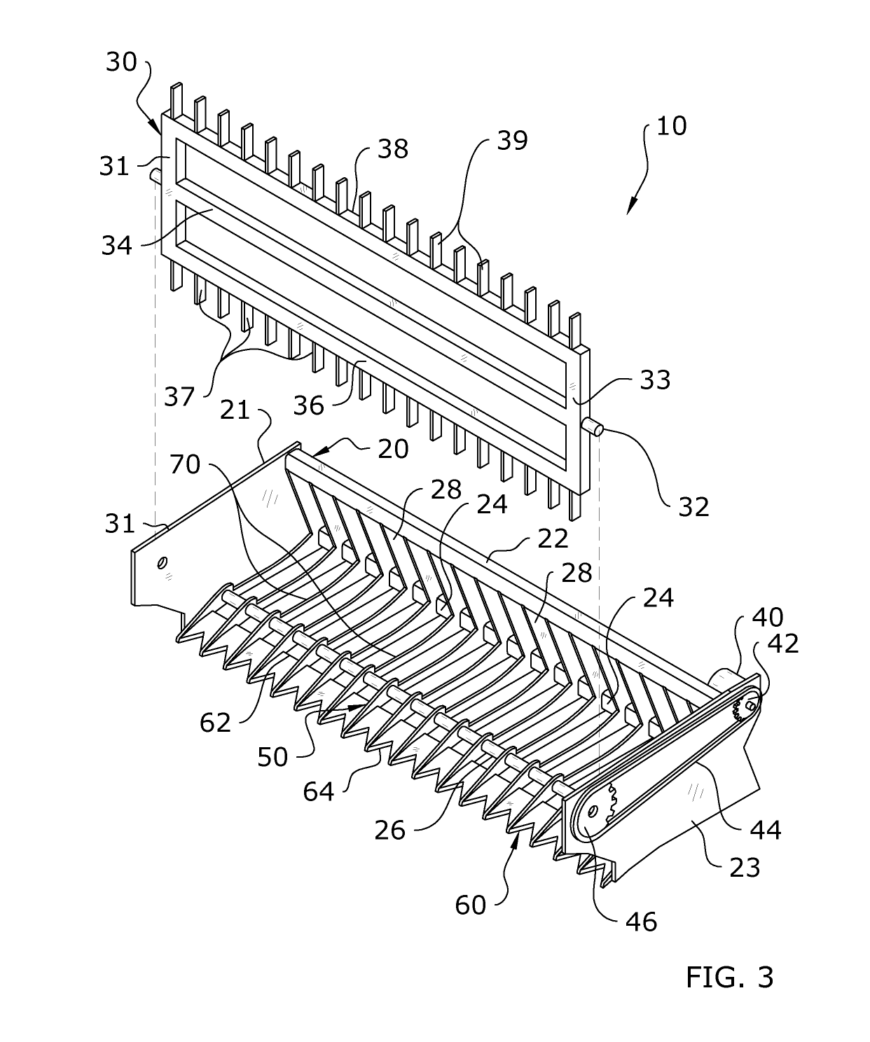

The frame 20 preferably includes a plurality of rib members having a plurality of slots between the rib members preferably construct the floor and rear wall of the frame 20 as illustrated in FIG. 3 of the drawings. The plurality of slots between the rib members allows smaller objects and dirt to fall through to avoid accumulation within the storage space of the frame 20 thereby retaining only rocks 11 of a minimum size. In particular, the frame 20 includes a plurality of lower support members 70 distally spaced apart from one another forming a plurality of lower slots and parallel with respect to one another to form a floor of the frame 20 and a plurality of rear members 28 distally spaced apart from one another forming a plurality of rear slots and parallel with respect to one another to form a rear wall of the frame 20 as illustrated in FIGS. 1 through 6 of the drawings.

### C. Reel Unit

The reel unit 30 is rotatably connected to a front portion of the frame 20 with at least a portion of the reel unit 30 positioned forwardly of the front teeth 50. The reel unit 30 is adapted to engage one or more rocks 11 in a rearward and upward manner to assist in directing the rocks 11 into the storage space of the frame 20 by lifting and pushing rearwardly the rocks 11 into the storage space as the frame 20 is moved forwardly by the tractor 12. In particular, the plurality of teeth provide a rearward and upward force to the rocks 11 as the rocks 11 engage the front teeth 50. The reel unit 30 is preferably comprised of a planar structure as illustrated in FIG. 3 of the drawings.

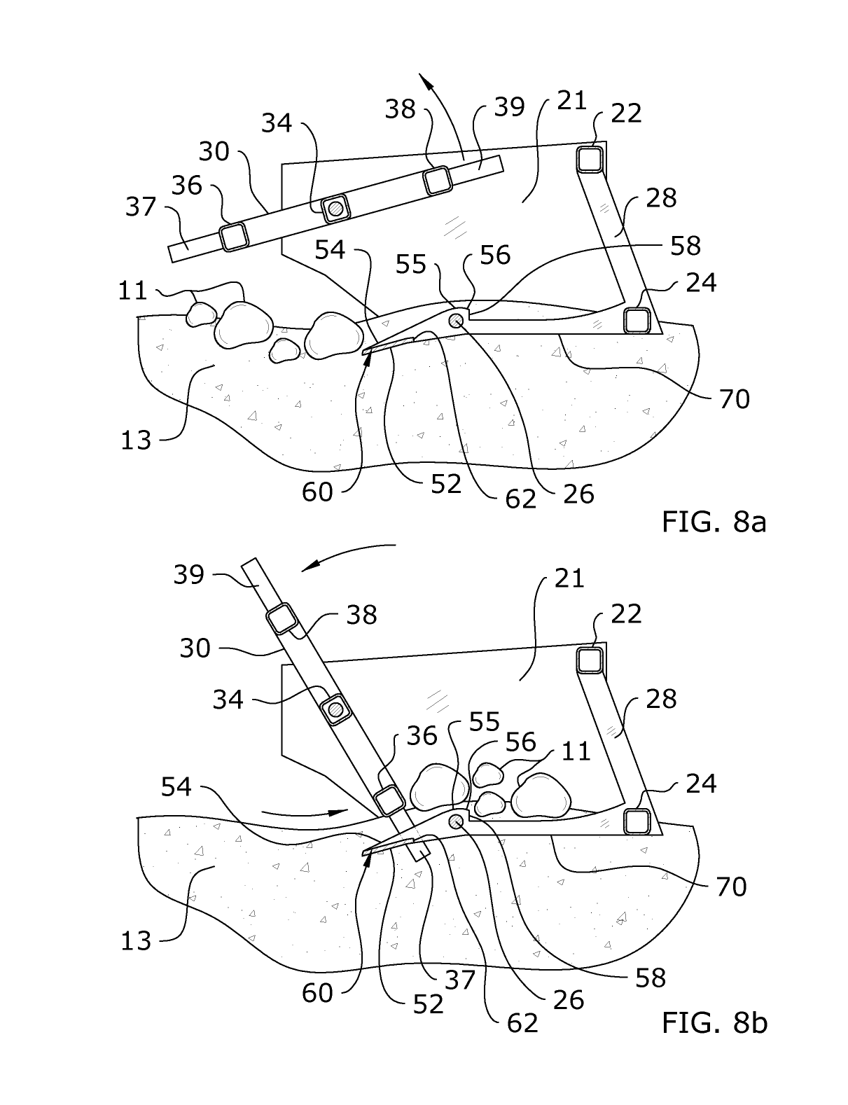

The reel unit 30 includes a plurality of teeth that assist in pushing the rocks 11 from a field 13 into the storage space of the frame 20. The plurality of teeth are aligned to extend between the plurality of front teeth 50 when the plurality of teeth are in a downward position as illustrated in FIG. 8b of the drawings.

The reel unit 30 is comprised of a first end member 31 rotatably connected to a right side of the frame 20, a second end member 33 rotatably connected to a left side of the frame 20, a center member 34 extending between the first end member 31 and the second end member 33, a first cross member 36 extending between corresponding first ends of the first end member 31 and the second end member 33, a second cross member 38 extending between corresponding second ends of the first end member 31 and the second end member 33, a plurality of first teeth 37 extending outwardly from the first cross member 36, and a plurality of second teeth 39 extending outwardly from the second cross member 38. The reel unit 30 preferably includes a reel axle 32 that is rotatably supported upon the frame 20.

The plurality of first teeth 37 preferably extend in a direction opposite of the plurality of second teeth 39. The plurality of first teeth 37 and the plurality of second teeth 39 extend radially from a common axis of the reel unit 30. The plurality of first teeth 37 and the plurality of second teeth 39 are each comprised of an elongated planar structure having a rectangular shape and is aligned along a plane, wherein the plane of the elongated planar structure is parallel with respect to a forward axis of the frame 20.

### D. Drive System

The motor 40 is attached to the frame 20 and is mechanically connected to the reel unit 30 to cause rotation of the reel unit 30. A reel sprocket 46 is preferably connected to the reel axle 32 with a chain 44 mechanically connecting the reel sprocket 46 to a drive sprocket 42 of the motor 40. The rotation of the motor 40 in a first direction causes the reel unit 30 to rotate in a first direction and the rotation of the motor 40 in a second direction causes the reel unit 30 to rotate in a second direction.

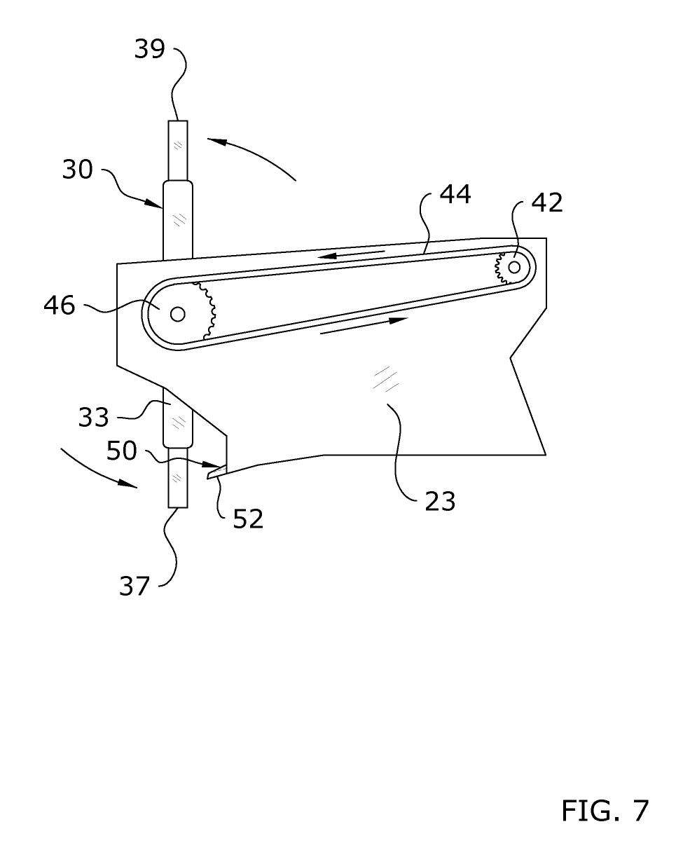

The motor 40 is preferably comprised of a hydraulic motor 40 but may be comprised of an electric motor 40, gas motor 40 or the like. The hydraulic motor 40 is adapted to be fluidly connected to a pressurized hydraulic system of a tractor 12 so that the operator of the tractor 12 may operate the rotation of the reel unit 30 from the cab of the tractor 12 (e.g. stopping the reel, starting rotation, direction of rotation). The motor 40 is preferably adapted to rotate the reel unit 30 in a first direction for loading the rocks 11 into the frame 20 as shown in FIGS. 7 through 8b of the drawings. The motor 40 is further preferably adapted to rotate the reel unit 30 in a second direction that is opposite of the first direction to allow for removing a stuck rock or removing debris that accumulates within the front teeth 50.

### E. Front Teeth

The plurality of front teeth 50 extend forwardly and downwardly from a lower front end of the frame 20, wherein the plurality of front teeth 50 engage, lift and direct the rocks 11 into the storage space as the frame 20 moves forwardly within a field 13. The plurality of front teeth 50 are preferably each comprised of a narrow structure that extends forwardly and downwardly. In addition, the plurality of front teeth 50 are preferably comprised of a planar structure that has a plane aligned with a vertical plane. The front teeth 50 may be permanently or removably connected to the frame 20 of the present invention. As illustrated in FIG. 3 of the drawings, the plurality of teeth are preferably integrally formed with the lower support members 70 and are attached to the front member 26 for spacing and support. The plurality of front teeth 50 further define front slots between the front teeth 50 that allow dirt and debris to fall through.

The plurality of front teeth 50 taper forwardly and downwardly as best illustrated in FIGS. 8a and 8b of the drawings. The plurality of front teeth 50 each include a lower edge 52, a first upper edge portion 54, a second upper edge portion 55 and a third upper edge portion 56 as further shown in FIGS. 8a and 8b of the drawings.

The first upper edge portion 54 is within a front portion of the plurality of front teeth 50 and the third upper edge portion 56 is within a rear portion of the plurality of front teeth 50 with the second upper edge portion 55 between thereof. The first upper edge portion 54 slopes downwardly at an angle that is preferably significantly greater than the second upper edge portion 55 and the third upper edge portion 56 with respect to a horizontal upper surface of the field 13. The angle of the first upper edge portion 54 is preferably at least 20 degrees downwardly from a horizontal plane. The first upper edge portion 54 may have a convex or concave curvature, however, it is preferable that the first upper edge portion 54 have a substantially straight structure. The second upper edge portion 55 is preferably approximately parallel with respect to the horizontal upper surface of the field 13 as illustrated in FIGS. 8a and 8b of the drawings.

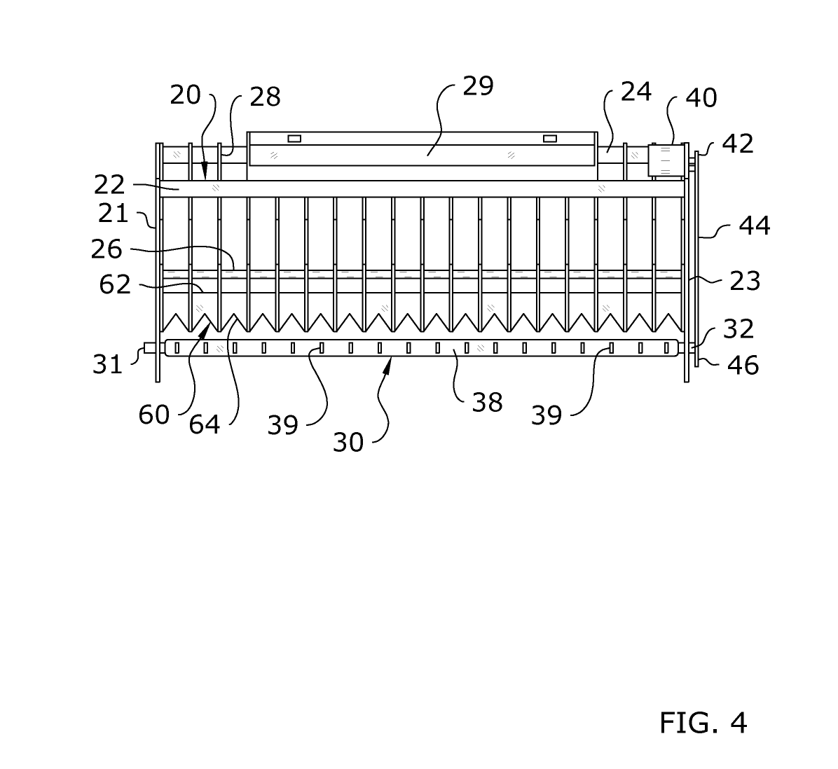

The plurality of front teeth 50 each include a rear edge portion 58 that extends downwardly from the third upper edge portion 56. The rear edge portion 58 extends downwardly to the upper surface of the lower support members 70 to form a catch structure that prevents the rocks 11 within the storage area from falling out of the storage space once accumulated within the same. Each of said plurality of front teeth 50 preferably includes a horizontal support 60 between each of the front teeth 50. The horizontal support 60 has a rear portion 62 angled upwardly and a tapered slot 64 within said horizontal support 60 that tapers rearwardly as illustrated in FIGS. 3 and 4 of the drawings. The rear portion 62 of the horizontal support 60 is preferably comprised of a solid structure that extends between two of the front teeth 50 to provide horizontal support 60 to the front teeth 50 to prevent the front teeth 50 from bending. The horizontal support 60 is preferably attached to a lower portion of the front teeth 50.

### F. Operation of Preferred Embodiment

In use, the user activates the motor 40 to cause rotation of the reel unit 30. The user then drives the tractor 12 forwardly and lowers the loader arms 14 of the tractor 12 thereby causing the front teeth 50 to extend into the upper surface of the field 13 as shown in FIGS. 8a and 8b of the drawings. As the tractor 12 and frame 20 moves forwardly through the field 13 in the lowered position, the front teeth 50 engage rocks 11 within the field 13 thereby lifting the rocks 11 upwardly and the teeth 37, 39 of the reel unit 30 then further assist in lifting and pushing the rocks 11 rearwardly into the storage space within the frame 20 defined by the floor, rear wall and sidewalls. The user continues operation until the storage space is substantially full. If a rock becomes caught between the teeth 37, 39 of the reel unit 30 and the front teeth 50, the user simply reverses the direction of the reel unit 30 thereby allowing the rock to fall out without the user having to get out and manually remove the rock. Once the storage space is full within the frame 20, the user then lifts the frame 20 upwardly and proceeds to a deposit area to unload the rocks 11 into (e.g. a rock pile). The user aligns the reel unit 30 so that the reel unit 30 is approximately horizontal and then forwardly tilts the frame 20 so that the rocks 11 fall outwardly from the storage space. Once the rocks 11 are removed, the use then repeats the above process.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A rock picking apparatus, comprising:
a frame having a storage space that receives a plurality of rocks;
a reel unit rotatably connected to a front portion of said frame, wherein said reel unit is adapted to engage one or more rocks in a rearward and upward manner to assist in directing said rocks into the storage space of the frame;
a motor mechanically connected to said reel unit to cause rotation of said reel unit; and
a plurality of front teeth extending forwardly and downwardly from a lower front end of said frame, wherein said plurality of front teeth engage, lift and direct said rocks into said storage space as said frame moves forwardly within a field.

2. The rock picking apparatus of claim 1, wherein said frame includes a rear connector attached to a rear portion, wherein said rear connector is adapted to be connected to a loader system of a tractor.

3. The rock picking apparatus of claim 2, wherein said rear connector is comprised of a quick attach structure to connect to a corresponding loader connector of a skid steer loader.

4. The rock picking apparatus of claim 1, wherein said motor is comprised of a hydraulic motor.

5. The rock picking apparatus of claim 4, wherein said hydraulic motor is adapted to be fluidly connected to a pressurized hydraulic system of a tractor.

6. The rock picking apparatus of claim 1, wherein said motor is adapted to rotate said reel unit in a first direction for loading said rocks into said frame and in a second direction to remove a stuck rock, wherein said second direction is opposite of said first direction.

7. The rock picking apparatus of claim 1, wherein said reel unit includes a plurality of teeth that assist in pushing said rocks from a field into said storage space of said frame.

8. The rock picking apparatus of claim 7, wherein said plurality of teeth are aligned to extend between said plurality of front teeth when said plurality of teeth are in a downward position.

9. The rock picking apparatus of claim 7, wherein said plurality of teeth provide a rearward and upward force to said rocks as said rocks engage said front teeth.

10. The rock picking apparatus of claim 1, wherein said reel unit is comprised of a first end member rotatably connected to a right side of said frame, a second end member rotatably connected to a left side of said frame, a first cross member extending between corresponding first ends of said first end member and said second end member, a second cross member extending between corresponding second ends of said first end member and said second end member, a plurality of first teeth extending outwardly from said first cross member, and a plurality of second teeth extending outwardly from said second cross member.

11. The rock picking apparatus of claim 10, wherein said plurality of first teeth extend in a direction opposite of said plurality of second teeth.

12. The rock picking apparatus of claim 10, wherein said plurality of first teeth and said plurality of second teeth extend radially from a common axis of said reel unit.

13. The rock picking apparatus of claim 10, wherein said plurality of first teeth and said plurality of second teeth are each comprised of an elongated planar structure having a rectangular shape and is aligned along a plane, wherein said plane of said elongated planar structure is parallel with respect to a forward axis of said frame.

14. The rock picking apparatus of claim 1, wherein said frame includes a plurality of lower support members distally spaced apart from one another forming a plurality of lower slots and parallel with respect to one another to form a floor of said frame and wherein said frame includes a plurality of rear members distally spaced apart from one another forming a plurality of rear slots and parallel with respect to one another to form a rear wall of said frame.

15. The rock picking apparatus of claim 1, wherein said plurality of front teeth taper forwardly.

16. The rock picking apparatus of claim 15, wherein said plurality of front teeth each include a lower edge, a first upper edge portion, a second upper edge portion and a third upper edge portion, wherein said first upper edge portion is within a front portion of said plurality of front teeth and wherein said first upper edge portion slopes downwardly at an angle greater than said second upper edge portion and said third upper edge portion with respect to a horizontal upper surface of said field.

17. The rock picking apparatus of claim 16, wherein said second upper edge portion is approximately parallel with respect to said horizontal upper surface of said field.

18. The rock picking apparatus of claim 16, wherein said plurality of front teeth each include a rear edge portion that extends downwardly from said third upper edge portion.

19. The rock picking apparatus of claim 16, wherein between each of said plurality of front teeth includes a horizontal support having a rear portion angled upwardly and a tapered slot within said horizontal support that tapers rearwardly.

20. The rock picking apparatus of claim 16, wherein said first upper edge portion slopes downwardly at an angle of at least 20 degrees.
